(19) United States
(12) Patent Application Publication
(10) Pub. No.: US 2014/0377720 A1
(43) Pub. Date: Dec. 25, 2014

(54) Method and System for providing Opening and Closing Instructions for Real Property

(71) Applicant: Pete Felix, Big Bear Lake, CA (US)

(72) Inventor: Pete Felix, Big Bear Lake, CA (US)

(21) Appl. No.: 14/313,846

(22) Filed: Jun. 24, 2014

Related U.S. Application Data
(60) Provisional application No. 61/838,834, filed on Jun. 24, 2013.

(51) Int. Cl. G09B 19/18; G09B 5/02

(52) U.S. Cl. CPC G09B 19/18; G09B 5/02
USPC 434/107

(57) ABSTRACT

A method and system for requesting instructional information via the internet. In the preferred embodiment the instructional information is to open and close a rental property such as a vacation home. The system consists of a client system and a server system. In the preferred embodiment a tenant will read a barcode, using a smartphone as the client system, which contains an identifier. The identifier will then be sent to a server system with a request create a list of tasks to open and close the property. The server system will then reply with a list of the requested tasks. The client system will allow the tenant to select a task and then send to the server system a request for instructional information related to the selected task. The server system will then respond back with the instructional information to the client system.

### CROSS-REFERENCE TO RELATED APPLICATIONS

This application claims priority from U.S. Provisional Patent Application No. 61/838,834 filed on Jun. 24, 2013. The entire disclosure of the prior application is considered to be part of the disclosure of the accompanying application and is hereby incorporated by reference.

In addition this application references the following U.S. patents and publications:
2012/0179727 filed January 2012 by Marla J. Esser;
2007/0033108 filed August 2005 by Stanley R. Luhr;
2005/0267900 filed March 2005 by Osman Ahmed, et al.;
2010/0161440 filed December 2008 by Travis Parton;
U.S. Pat. No. 8,442,887 filed August 2012 by Dennis C. Hamann;
U.S. Pat. No. 6,853,958 filed June 2000 by Jody L. Turin, et al.;
2008/0262879 filed November 2007 by William Barry Furlong, et al.;
2006/0282275 filed June 2005 by Douglass D. Pineda, et al.; and
U.S. Pat. No. 8,145,613 filed September 2007 by Lacey Michelle Colletti.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention relates to a method for providing instructional material, and more particularly to a method for providing instructional material for the purpose of instructing tenants, property managers, maintenance/repair personnel, inspectors, and other interested individuals of a human dwelling facility on opening and closing or turning on and off various systems that pertain to the human dwelling facility such as but not limited to utility, entertainment, and environmental control. A human dwelling facility is any facility designed to support the continuous presence of humans where provided services such as water, electricity, gas, television cable, internet, and the such are shared. A typical example would be a home. Other examples would include apartment complexes or full service campgrounds. A human dwelling facility may be considered permanent, that is an individual's domicile, or temporary/rental, such as a vacation home. For the remainder of this description human dwelling facility will be abbreviated HDF. Opening and closing a HDF refers to those tasks that are needed to “boot up” and “shut down”, using analogous terms as applied towards computers, a HDF. Examples of tasks to open a home include turning on the water main, lighting the pilot light for a gas water heater, setting the thermostat. Tasks to close a home are usually the reverse of those tasks to open a home.

2. Description of the Related Art

Rental HDFs such as vacation homes, condos, and cabins are increasingly becoming more complex as potential tenants demand access to features such as WiFi, Pay-per-view, local printing, and expecting features such as water, electricity, and gas. Tenants look for rental HDFs that provide all, if not more, of the features that their permanent HDF provides. Rental HDFs that only provides the most basic features such as water, electricity, and gas may be overlooked by potential tenants or must be offered at substantial discounts to attract potential tenants. However as landlords have added features to their rental HDFs there arose the problem of instructing the various tenants of the rental HDFs on how to properly use all of these features. This problem is also compounded if the landlord is not accessible to assist the new tenant in accessing these features or if a property manager, who has been retained by the landlord, does not have sufficient knowledge of the particular HDF to provide these instructions. Newer and more technical features have not diminished the importance of older and more basic features such as water, electricity, and gas. These features, while lacking the glamour of more high tech features, are essential for a satisfactory living experience by the tenant. Yet these older and more basic features may require a more complex set of instructions than other features due to the need of weatherizing or temporarily shutting down the rental HDF between tenants in addition to the fact that the location and arrangement of main water and gas valves as well as electrical panels differ between properties.

There exists a multitude of prior art for methods and systems that are associated with the management and maintenance of HDFs and these may be divided into three categories. The first category being prior art for methods and systems that teach means of tracking the contents of a HDF for the purposes of warranty, installation, and maintenance of these contents. The second being a category of prior art for methods and systems that teach means of tracking inventory of rental HDFs for the purpose of transacting with prospective tenants. The third being a category of prior art for methods and systems that teach means of management of HDFs for the purpose of providing services to the owner of the HDF.

For the category of prior art for methods and systems that teach means of tracking the contents of a HDF for the purposes of warranty, installation, and maintenance of these contents a sample set of prior art include US 2012/0179727 titled “Interactive Home Manual with Networked Database”, US 2007/0033108 titled “Systems and Methods for Tracking Component-Related Information Associated with Buildings”, US 2005/0267900 titled “Method and system for organizing data relating to a home”. The content that is tracked in this category include features of construction, fixtures and non-fixtures of the HDF, identification of manufacturing, distribution, and installation sources/services, warranty, preventative maintenance schedules, custom installation instructions, recall alerts, and more. However this category of prior art does not address the need to provide tenants of a HDF instruction on enabling and disabling features of the HDF. Instructions for a key task such as how to turn off the main water line when closing the HDF at the end of a rental period is not addressed. Likewise this category of prior art does not teach how to instruct tenants opening a HDF at the start of a rental period or how to log into the HDF's WiFi network during the rental period.

For the category of prior art for methods and systems that teach means of tracking inventory of rental HDFs for the purpose of transacting with prospective tenants a sample set of prior art include US 2008/0262879 titled “Short-term Housing Rental Management System and Method”, US 2006/0282275 titled “Survey Method for Facilitating Real Estate Transactions”, and U.S. Pat. No. 8,145,613 titled “System, method and apparatus for tracking and rating renters”. This category teaches methods and means of managing HDFs for the purpose of providing a set of services for presenting, determining availability, qualifying, and reserving the HDF. However this category of prior art does not address the need to provide tenants of HDF instruction on enabling and disabling features of the HDF during their rental term. As mentioned above instructions for tasks such as how to turn off the main water line when closing the rental HDF at the end of the rental period or how to log into the HDF's WiFi network during the rental period are not taught.

For the category of prior art for methods and systems that teach means of management of HDFs for the purpose of providing services to the owner of a HDF a sample set of prior art include US 2010/0161440 titled “A Method for the Upkeep of a Residence”, U.S. Pat. No. 8,442,887 titled “Method and system for providing services to vacation homeowners”, and U.S. Pat. No. 6,853,958 titled “System and method for collecting and disseminating household information and for coordinating repair and maintenance services”. This category teaches methods and means for services that primarily benefit the owner of the HDF by providing alerts for scheduled maintenance, valuation of maintenance services, and tracking and reporting these services to the owner of the HDF. However this category of prior art does not address the need to provide tenants of the HDF instruction on enabling and disabling features of the HDF during their rental term. As mentioned above instructions for tasks such as how to turn off the main water line when closing the HDF at the end of the rental period or how to log into the HDF's WiFi network during the rental period are not taught.

Prior do not teach a method of providing to a tenant of a HDF instructions on opening the HDF at the start of the rental term or dosing the HDF at the end of the rental term. In addition prior art do not teach a system of how these instructions are made available to the tenant.

### BRIEF SUMMARY OF THE INVENTION

The present invention provides a method and system for the requesting of instructions that are needed to perform a task. The method makes good use of existing established technology that are familiar to individuals who will be utilizing the method making it simple to execute. Additionally, as the method makes use of certain identifiers, the method may be made as secure as the identifiers are made secure. Finally the method and system may be broadly applied towards a number of situations where an identifier for instructional information is available to a user who needs the instructional information. For example an identifier may be placed within an automobile so that an individual needing instructions on using the automobile may simply enter the identifier into the present invention and have the instructions made available to them.

The preferred embodiment of the present invention teaches a method of providing to a tenant of a HDF instructions on tasks to open the HDF at the start of the rental term, tasks to close the HDF at the end of the rental term, and tasks for controlling and accessing features of the HDF. The method taught by the present invention to acquire the instructions basically involve the sequence of the tenant reading an identifier into a client system, accessing a server system where the list of tasks are stored, retrieving a list of tasks that are available for that HDF, selecting a task that they need assistance with, and then viewing instructions for that task.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

The present invention will become more fully understood from the detailed description and accompanying drawings, wherein:

FIG. 1 is a block diagram illustrating an embodiment of the present invention.

FIG. 2 is a flow diagram of a client system routine to request a set of tasks that are associated with an identifier to a server system.

FIG. 3 is a flow diagram of a server system routine to process a client system request for a set of tasks associated with an identifier.

FIG. 4 is a flow diagram of a client system routine to display a set of tasks, allow for the selection of an task, send a request to a server system for instructional information associated with the task.

FIG. 5 is a flow diagram of a server system routine to process a client system request for instructional information for a task associated with an identifier.

### DETAILED DESCRIPTION OF THE INVENTION

The following description of the preferred embodiment(s) is merely exemplary in nature and no way intended to limit the invention, its application, or uses.

The present invention provides a method and system for the requesting of instructions that are needed to perform a task. Although this method and system may be broadly applied towards a number of different embodiments here the preferred embodiment is for transforming an identifier into instructional information on tasks needed to open a HDF at the start of the rental term, to close a HDF at the end of the rental term, and for controlling and accessing features of a HDF using established technologies that are easily accessible and understood.

The present invention makes use of two systems: a client and a server. The two systems work together with the client system being primarily responsible for reading an identifier, displaying tasks associated with the identifier, and displaying instructions associated with a task and the server system being primarily responsible for storing tasks and instructions associated with identifiers and sending the same to the client system. In the preferred embodiment of the present invention a tenant will enter a vacation home on Sunday at the start of a week long vacation. While the vacation home is empty, in between tenants, the vacation home's access to utilities such as water, gas, and electricity may be turned off to reduce utility costs or for weather proofing the vacation home. The tenant, being new to the HDF or having not taken possession of the HDF for an extended period of time, will likely not know how to turn on the utilities. The tenant would be instructed that upon entering the home they will proceed to a certain location within the home where an identifier will be located. The identifier may be represented by a number of means such as a code of letters, numbers, and special characters like a password, a barcode in any number of formats such as EAN, UPC, and the such, or, in the preferred embodiment, a Quick Response (QR) Code. In addition the identifier may be stored in a secure location requiring a key or code to retrieve the identifier or the identifier may be located in an easily accessible location. The tenant, using an internet enabled device, will read the identifier and be presented with a list of tasks, a subset of which will instruct the tenant how to turn on utilities, entertainment, or environmental systems or otherwise “open” the vacation home for their benefit. In addition during the tenant's stay at the vacation home they may encounter issues that are easily resolved if the tenant had access to appropriate instructions. Example include logging into the vacation home's WiFi or how to turn on the water heater's pilot flame. Again by using an internet enabled device and reading the identifier the tenant will be presented with a list of tasks a subset of which may include instructions on how to log into the home's WiFi or how to light the pilot flame on the gas water heater. Finally at the end of the tenant's stay there may be certain tasks that they need to perform as part of closing the vacation home. Examples may include where to leave the key, taking out the garbage, properly turning off the water to reduce the risk that a pipe will burst. By using an internet enabled device and reading the identifier the tenant will be presented with a list of tasks a subset of which may include instructions on how to “close” the vacation home.

The specifics of the present invention is described in the following paragraphs which will reference the included figures. However a detailed summary of the preferred embodiment is as follows. The client system will be an internet enabled device with an optical sensor and software to communicate with a remote server system, read QR codes, and display information sent by the server software. Typically this will be a smartphone running a QR code reader along with a browser or a custom application. The server system will be an internet enabled computer. At its simplest configuration the server system will store all of the instructional videos that are related to a HDF as files that are accessible by means of a Uniform Resource Locator (URL). The files are then served to the client system using standard off the shelf internet server software. At its most complex configuration the server system will run a custom application where the instructional videos will be stored in a database that is access by the custom application. The custom application will interface with the client system and respond to requests by the client system. Within the vacation home a QR code that contains the identifier associated with the vacation home will be used. A tenant, when needing instructions on opening or closing the vacation home, will start a custom app on their smartphone that implements the present invention. The tenant will then read the QR code using the camera on their smartphone and from the QA code the custom app will decode the identifier and send the identifier to the server system and await a reply from the server system. The server system, upon receiving the identifier from the client system, will build a list of tasks that are available for the vacation home along with an identifier for each task and send the list to the client system. The client system, upon receiving the list of tasks, will present the list to the tenant and allow the tenant to make a selection. Once the tenant makes a selection the custom app will create a request and send the request to the server system to reply back with the instructions for the task. The server system, upon receiving the request for instructions from the client system's custom app, will locate the instructions and stream it back to the client system for display to the tenant. So the problem of providing a tenant of a vacation home with instructions on opening and closing the vacation home as well as instructions for other issues that the tenant may encounter is easily solved by the novel use of QR codes, internet technology, and media files.

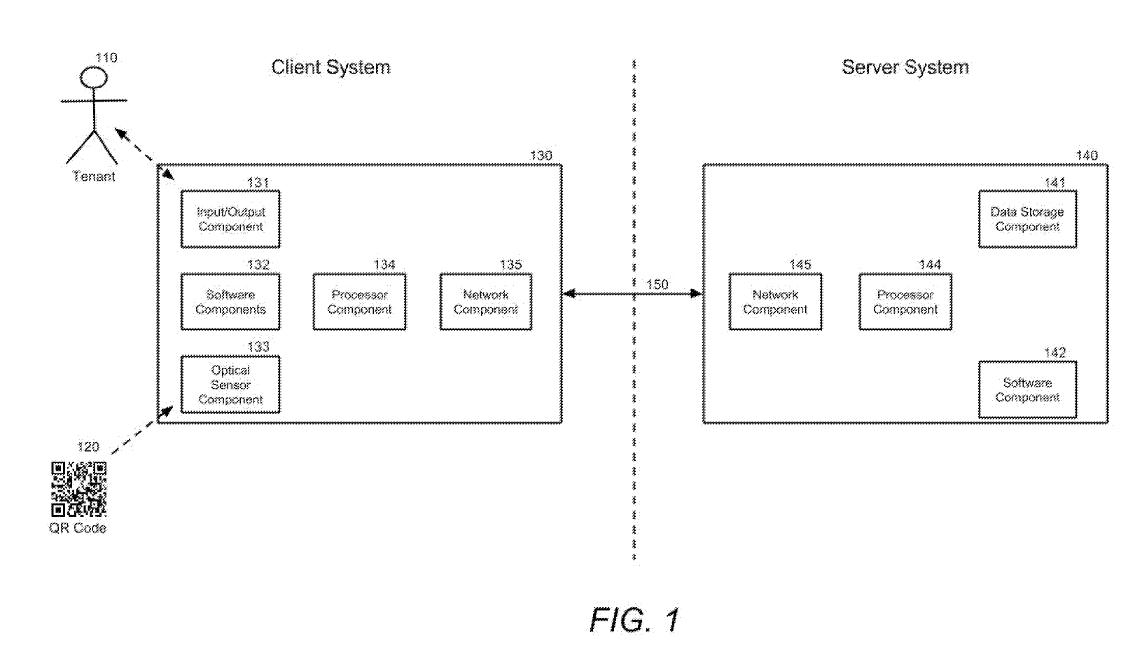

FIG. 1 provides a system overview of both client system 130 and server system 140 along with external elements such as tenant 110, QR Code 120, and network 150. The client system is shown in its preferred embodiment as optical sensor 133 reading QR Code 120 is included. Input/Output component 131 in the preferred embodiment is the touch sensitive display of a smartphone but may be the display and keyboard of any internet enabled device. Input/Output component 131 is used to display to tenant 110 a list of available tasks or instructions for an individual task as well as to allow tenant 110 to select a task from a list of tasks. In the preferred embodiment tasks are those undertakings that must be performed by the tenant to open and close a HDF. To open a HDF means to activate those services that are needed in order to make the tenant's stay pleasant and comfortable. To close a HDF means to deactivate those services that are no longer needed and to take those steps necessary to protect the HDF from any severe weather conditions that may damage the HDF. While input/output component 131 is the interface between client system 130 and tenant 110, optical sensor component 133 is the interface between client system 130 and QR Code 120. In the preferred embodiment optical sensor component 133 is a camera. Processor component 134 will execute software component 132. Software component 132 may be a combination of apps such as a browser and a QR Code reader or in the preferred embodiment a single custom app. Software component 132 will need to send and receive information over network 150, control input/output component 131 and optical sensor component 120, and extract the HDF's identifier from QR Code 120. Server system 140 is a computer with access to network 150 so that it may communicate with client system 130. Data storage component 141 will be used to store instructions that are specific to a task and lists of tasks that are specific to a HDF. In the preferred embodiment data storage component 141 will be a SQL relational database but in other embodiments data storage component 141 may simply store instructional information as files within server system's 140 file structure. Processor component 144 will execute software component 142. Software component 142 consist of an internet server software as well as custom software necessary to read requests sent by client system 130, use identifiers sent by client system 130 to lookup instructional information, create web pages containing lists of tasks, and stream instructional information to the client system 130. Finally network 150 may be any network that will allow client system 130 and server system 140 to communicate with each others. In the preferred embodiment network 150 is the internet.

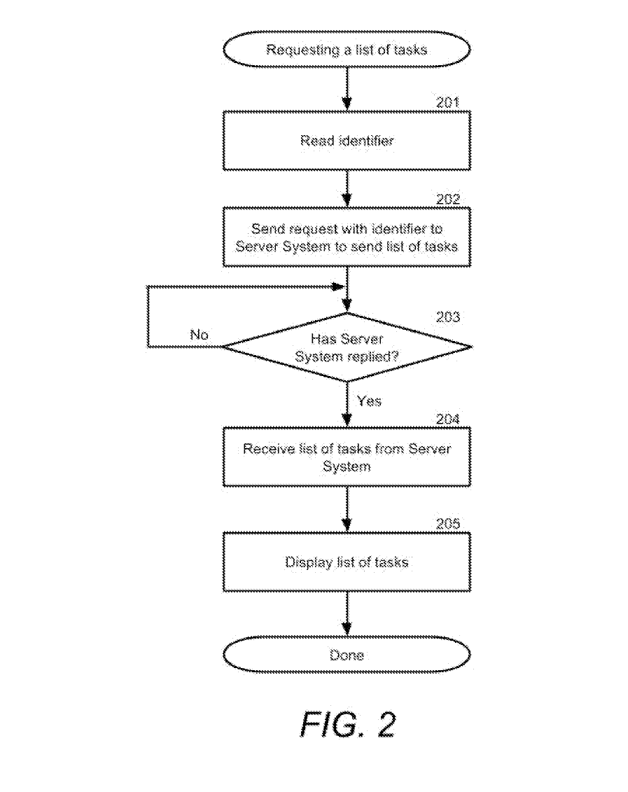

FIG. 2 displays a flow diagram showing code that will be executed on client system 130 so that input/output component 131 will show a list of tasks to open and close a HDF. Before any of the steps in FIG. 2 may be executed client system 130 must have access to the identifier for the HDF. In step 201 client system 130 will read the identifier. In the preferred embodiment identifier will be QR Code 120 but as discussed earlier the identifier may take on any form so long as each identifier is only associated with one HDF. In step 202 client system 130 will create a request to be sent to server system 140 over network 150 for server system 140 to reply back with list of tasks to open and close the HDF. Embedded within the request will be the identifier read in step 201 for the HDF. Software component 132 may encrypt the identifier. In step 203 client system 130 will wait for a response from server system 140. In step 204 client system 130 receives the response from server system 140 that contains a list of the tasks to open and close the HDF. If software component 132 is a browser the response will be a web page. If software component 132 is a custom app the response may be in another form. In step 205 client system 130 will display the list of tasks to tenant 110 so that tenant 110 may select one of the tasks to view instructions related to that task.

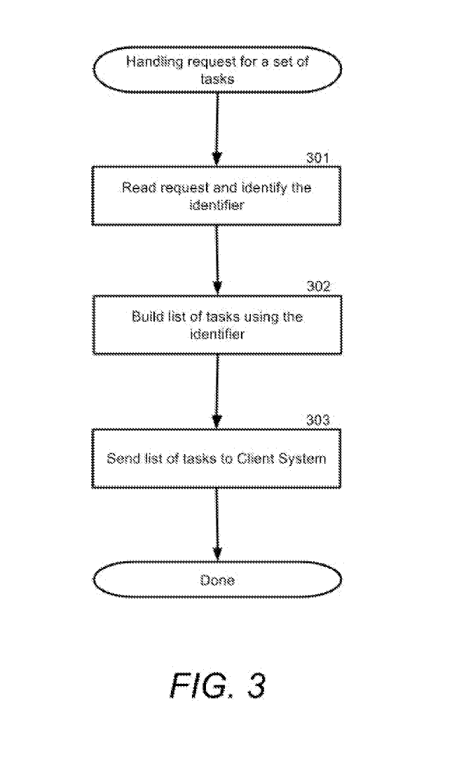

FIG. 3 displays a flow diagram showing code that will be executed on server system 140 that will create a list of tasks for a particular HDF. In step 301 server system 140 will read the request sent by client system 130 in step 202. The request will inform server system 140 that client system 130 is requesting a list of tasks for a particular HDF. The request will contain an identifier that is associated with the particular HDF. Step 301 will contain code that will understand how to locate the identifier within the request and to decode the identifier if it is encrypted. In step 302 server system 140 will use the identifier to locate within data storage component 141 the list of tasks that belong to a HDF. In step 303 server system 140 will send the list of tasks to client system 130. The list may be in the form of an HTML web page if client system's 130 software component 132 is a browser. If software component 132 is a custom app then the list of tasks may take on any number of appropriate forms. The steps in FIG. 3 are executed while client system 130 is waiting as shown in step 203.

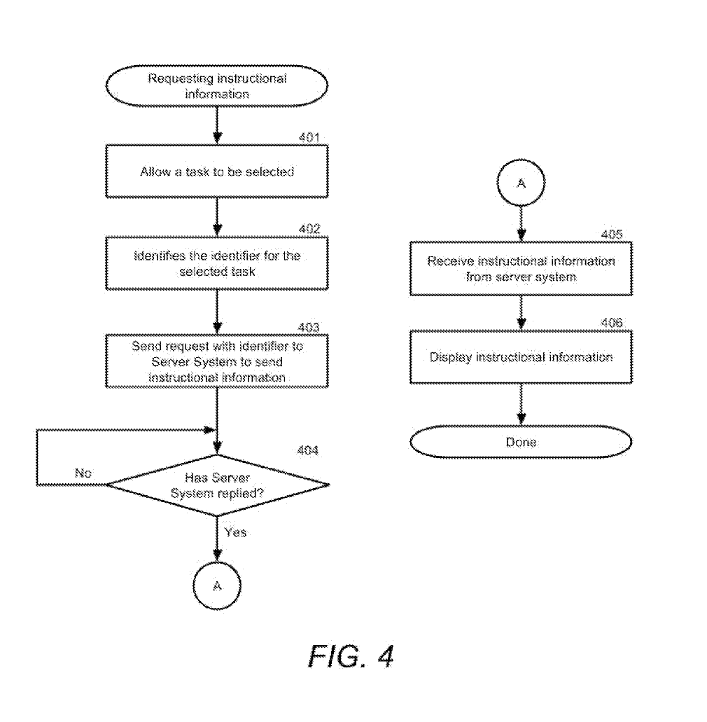

FIG. 4 displays a flow diagram showing code that will be executed on client system 130 that will start from where a list of tasks were displayed to tenant 110 using input/output component 131 in step 205. In step 401 client system 130 has allowed tenant 110 to select one task from the list of tasks displayed to tenant 110 using input/output component 131 in step 205. In step 402 client system 130 will locate the identifier for the task selected by tenant 110. If client system's 130 software component 132 is a browser the identifier for the instruction will be found embedded in the link for the task in the list of tasks. If client system's 130 software component 132 is a custom app the identifier for the instruction will be found in a data structure in the custom app and may be encrypted. In step 403 client system 130 will send a second form of a request to server system 140. This request will be for instructions to perform the selected task and within the request will be embedded the identifier for the instructions. In step 404 client system 130 will wait for server system 140 to process the request and respond back. In step 405 client system 130 will receive from server system 140 the instructions for the task selected in step 401. In the preferred embodiment the instructions will be in the form of a video but instructions may also be in the form of text with images or audio with images. Finally in step 406 client system 130 will display the instructions to tenant 110 using input/output component 131.

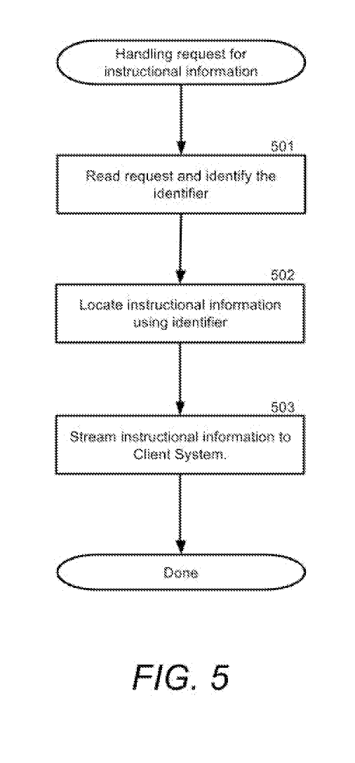

FIG. 5 displays a flow diagram showing code that will be executed on server system 140 that will send instructions for a particular task to client system 130. In step 501 server system 140 will read the request sent by client system 130 in step 403. The request will inform server system 140 that client system 130 is requesting instructions for a particular task. The request will contain an identifier that is associated with the particular task. Step 501 will contain code that will understand how to locate the identifier within the request and to decode the identifier if it is encrypted. In step 502 server system 140 will use the identifier to locate within data storage component 141 the instructions that belong to the particular task. In step 503 server system 140 will stream the instructions to client system 130. In the preferred embodiment the instructions will be streamed as a video however other embodiments may stream instructions as text with images or audio with images.

Although the present invention has been described in terms of various embodiments, it is not intended that the invention be limited to these embodiments. Modifications within the spirit of the invention will be apparent to those skilled in the art.

What is claimed is:

1. A method of retrieving instructional information for a task comprising:
under control of a client system,
reading a first identifier for a set of tasks; and
sending a first request with the first identifier to a server system;
under control of a server system,
receiving the first request and the first identifier;
retrieving the set of tasks identified by the first identifier;
creating a list of the set of tasks with each task having a second identifier; and
sending the list to the client system;
under control of the client system,
receiving the list from the server system;
displaying the list;
allowing the selection of a task from the list;
retrieving the second identifier for the selected task; and
sending a second internet request with the second identifier to the server system;
under control of the server system,
receiving the second internet request and the second identifier;
retrieving the instructional information identified by the second identifier; and
sending the instructional information to the client system;
under control of the client system,
receiving the instructional information from the server system; and
displaying the instructional information.

2. The method of claim 1 wherein the reading of a first identifier is by scanning a linear or matrix barcode.

3. The method of claim 1 wherein the instructional information is comprised of images, text, audio, and video.

4. The method of claim 3 wherein the instructional information is comprised of video.

5. The method of claim 1 wherein the tasks are limited to those steps required to enable and disable features of a human dwelling facility.

6. The method of claim 5 wherein the features are limited to those required for opening and closing the human dwelling facility.

7. The method of claim 6 wherein the human dwelling facility is a short term rental property.

8. The method of claim 6 wherein the human dwelling facility is a campground.

9. A client system for requesting and displaying instructional information comprising:
a display component for displaying a list of tasks and instructional information for a task;
a processor component for executing software components;
a network component for communicating with a server system;
a software component that in response to reading a first identifier, sends a request to a server system to send a set of tasks associated with first identifier, retrieve the set of tasks sent by the server system, allows the selection of one task from the set of tasks, identifies second identifier for the task selected from the set of tasks, sends second request to the server system with second identifier to send instructional information associated with second identifier, retrieves instructional information sent by server system, and displaying the instructional information using said display, processor, and network components;

10. The client system of claim 9 wherein the software component is a browser.

11. The client system of claim 9 that further comprises an optical sensor component.

12. The client system of claim 11 wherein the software component comprises a browser and optical image decoder.

13. The client system of claim 11 wherein the software component is a custom app

14. A server system for retrieving a request for instructional information and replying with the requested instructional information comprising:
a data storage component for storing a plurality of instructional information and lists of tasks;
a processor component for executing software components;
a network component for communicating with a client system;
a software component that receives requests and identifiers from a client system, upon receiving a request and identifier will decode the request as being a request for a list of tasks or for instructional information, will use the identifier to locate the list of tasks or instructional information being requested, and send the requested list of tasks or instructional information to a client system.

15. A method for requesting and viewing instructional information using a client system, the method comprising:
reading a first identifier that identifies a set of tasks;
sending to a server system a first request to view a set of tasks associated with the first identifier;
receiving from the server system the set of tasks and an identifier for each task;
displaying the set of tasks;
allowing the selection of a task from the set of tasks;
determining a second identifier for the selected task;
sending to a server system a second request with the second identifier to view instructional information associated with the second identifier;
receiving from the server system the instruction information; and
displaying the instructional information.

16. The method of claim 15 wherein the reading of first identifier is by scanning a linear or matrix barcode.

17. The method of claim 15 wherein the first and second identifiers are encrypted.

18. The method of claim 15 wherein the client system and server system communicate via the Internet.
